(19) United States
(12) Patent Application Publication
(10) Pub. No.: US 2006/0226988 A1
(43) Pub. Date: Oct. 12, 2006

(54) Hotel mini bar automation system

(76) Inventors: Nick Ernst, Victoria (CA); Ian Soutar, Victoria (CA); Edmund Haslam, Victoria (CA)

Correspondence Address: Diane Kneeland, 148 Pecos St., Cedar Creek, TX, 78612, US

(21) Appl. No.: 11/402,451

(22) Filed: Apr. 12, 2006

Related U.S. Application Data
(60) Provisional application No. 60/670,156, filed on Apr. 12, 2005.

(51) Int. Cl. G08B 13/14

(52) U.S. Cl. 340/572.1; 340/5.92

(57) ABSTRACT

A mini-bar and a system and a method of monitoring activity of a mini-bar where the mini-bar includes radio frequency identification tags which communicate the status of inventory to a central system for billing and restocking purposes.

### CROSS REFERENCE TO RELATED APPLICATIONS

This application claims the benefit of PPA 60/670,156 filed 2005 Apr. 12 by the present inventors

### FEDERALLY SPONSORED RESEARCH

Not applicable

### SEQUENCE LISTING OR PROGRAM

Not applicable

### BACKGROUND OF THE INVENTION:

1. Field of the Invention

This invention relates generally to monitoring systems and, more particularly, to a system for monitoring the inventory in a hotel mini-bar.

2. Prior Art

Originally, the inventory in mini-bars in hotels, motels, inns, etc. was checked manually during the guest's stay, or after a guest checked out, and the guest was charged for the items missing from the mini-bar. The disadvantage of manual checking includes the labor involved, the interruption of guest's privacy, and the possibility that someone other than the guest might consume items from the mini-bar after the guest has left, or that the mini-bar was not properly restocked before the guest arrived.

Monitoring devices for mini-bars include door switches, which indicate that the door has been opened. Door switches fail to indicate that an item has been removed from the mini-bar. Pressure sensitive switches or infrared barriers have also been employed to indicate when an item has been removed from the cabinet. However, a switch or barrier will not indicate if an item has been returned to the cabinet. Recently a system and method of viewing mini-bar status has been proposed by Buckingham et al (US Patent Application 20050206725) by imaging the interior of the mini-bar and comparing differences in the present image to that of the perfectly stocked cabinet. The system still fails to track individual items of inventory, rather it depends on the whole interior of the cabinet looking the same or different at the time that that housekeeping staff look at the image of the cabinet interior. A system of tracking individual items of inventory on a continuous basis is needed, such that an item that has been removed from the cabinet and then returned unopened will not be charged to the guest, but an item that is removed and consumed will be automatically charged at the time that it is recorded as missing from the cabinet.

### OBJECTS AND ADVANTAGES

Accordingly, several objects and advantages of the present invention over the prior art include the ability to continuously monitor individual items within the min-bar cabinet, rather than monitoring the operation of the cabinet itself, for example monitoring whether the door of the cabinet has been opened. Another advantage is that the status of items at any time can be determined, so the time at which an item is removed from or returned to a cabinet can be ascertained. Also, the consumed or intact condition of each item is being continuously monitored.

Another advantage of the present invention is that charges for consumed items can be recorded at the time that the item is consumed, instead of waiting until housekeeping has visually determined that an item is missing from the cabinet. Therefore at the time that the customer checks out of the hotel, all mini-bar charges are itemized.

Further objects and advantages will become apparent from a consideration of the drawings and ensuing description.

### SUMMARY

The present invention is for a method of continuously monitoring the inventory in a storage cabinet such as a mini-bar in a hotel room, and communicating the inventory status to a central location for restocking and billing purposes.

### DRAWINGS

FIG. 1 describes the radio or other wireless link such as wireless internet (WiFi) connecting the mini-bar to the Building Wide Communication Network (BCN).

FIG. 2 shows how the radio frequency identification (RFID) tag reader is used to detect items removed from the cabinet. If a tag goes out of range (some distance such as 0.5 meters) then the guest's room ID code or the cabinet's ID code along with the RFID tag code is sent wirelessly to the room area. The wireless communication can be either a simple data radio or a WiFi data link.

FIG. 3 is an overall view of the guest room instrumentation. It shows how tags that are out of range will be easily detected.

### REFERENCE NUMERALS

1—RFID tag beyond range
2—Mini-bar cabinet antenna
3—Radio or WiFi link
4—ID code
5—Mini-bar microcontroller
6—RFID Reader
7—RFID Reader Antenna
8—Transmitted Inventory Data
9—RFID Tag in Range
10—RFID Tag in Range
11—Wall BCN Link Module Data Receiver
12—Data from Data Receiver to Microcontroller
13—Wall BCN Link Module Microcontroller
14—Data from Microcontroller to Serial/Ethernet Link
15—Wall BCN Link Module Serial/Ethernet Link
16—Data from Wall BCN Link Module to Building Communication Network
17—Building Communication Network
18—5 Volt Regulator
19—Wall Type 12 Volt Supply
20—Wall BCN Link Module Antenna
21—Wall Radio Link to Internet or to Telephone, or WiFi Wireless Internet
22—Internet or Telephone Building Communication Network
23—RFID Tagged items inside Mini-bar
24—Mini-bar
25—RFID Tag Range Limit
26—Item with RFID Tag Out of Range; Reported as Purchased
27—Mini-bar Wireless Internet (WiFi) or Radio Link

### DETAILED DESCRIPTION

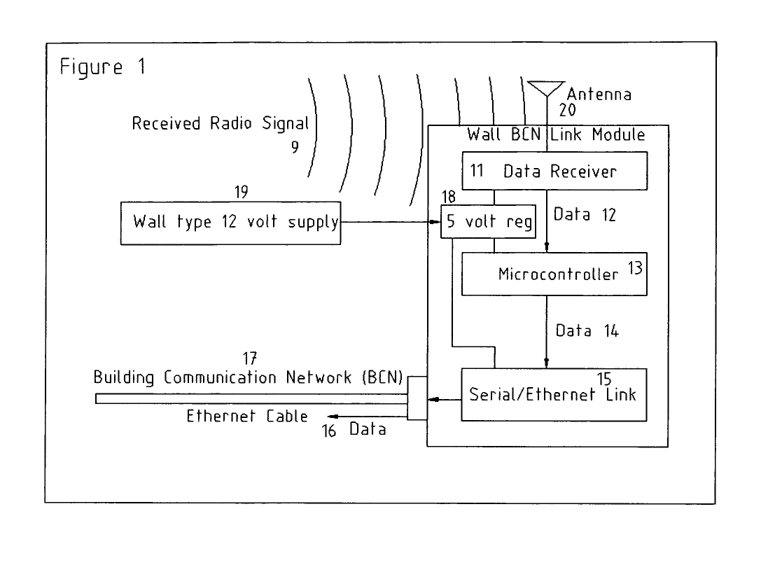

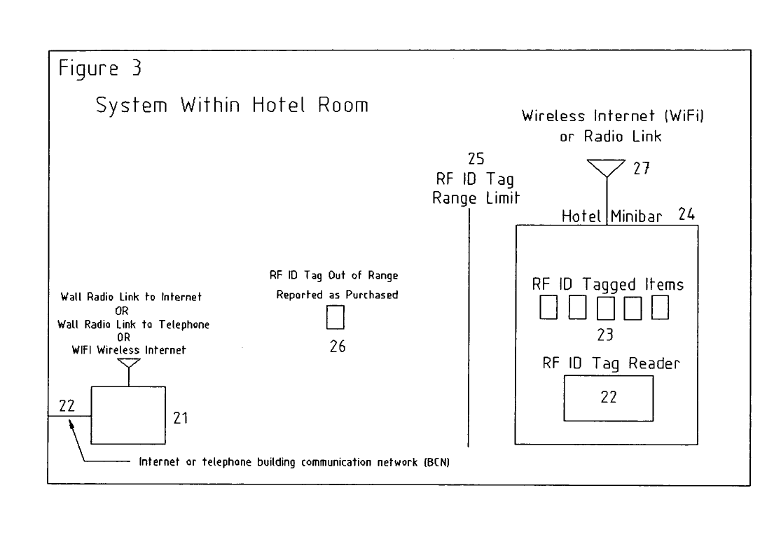

### Preferred Embodiment—FIGS. 1-3

A mini-bar or amenity cabinet is an (often refrigerated) cabinet containing food, juice, soft drinks and liquor. When the guests in a room use these items they are charged on their room bill. In the preferred embodiment as seen in FIG. 1-3, all items in the mini-bar are tagged with RFID or Radio Frequency Identification Tags (23). The RFID Tag is a standard product tagging system which is expected to replace the bar code.

Near the wall of the room, and near either the telephone line or the internet connection there will be either a standard wireless internet router (21) or the receiver for the data radio transmissions that are sent from the cabinet (24).

The word “internet” is being used in this case to mean either a local Ethernet based network system or a wireless network system. It may or may not use the TCP/IP protocol as is usually used for internet linking. A microcontroller (5), a small single chip computer such as the Microchip 16f876, is included in the mini-bar.

### Operation—Preferred Embodiment

This system is designed to allow charges to be automatically recorded for the room whenever items are removed from the mini-bar. The following sequence describes the use of the system.

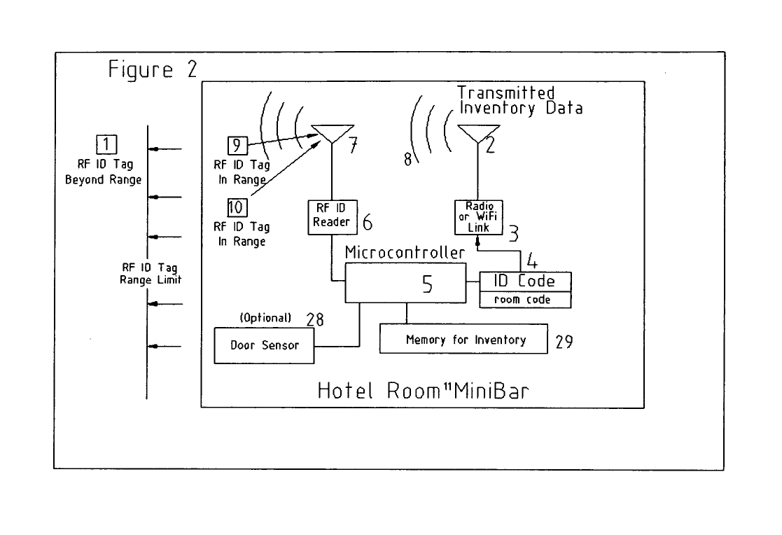

All items in the mini-bar (24) are tagged with RFID or Radio Frequency Identification tags (23). These RFID tags (23) can be read by a radio tag reader (6) from a distance of about a half meter. The range can be adjusted. The reader (6) works by sending out a radio signal. This energizes the tag (9 and 10) which sends back its identification number or code. Looking at FIG. 2, the RFID tag reader (23) sends out a signal from its antenna (7) to tags (9 and 10). The identification code is sent back to the reader. However the tag marked (1) does not send its identity because it is out of range.

All items in the mini-bar (24) are interrogated by the reader at regular intervals such as every minute. The RFID technology can read multiple tags at once.

The interrogation is carried out by the microcontroller (5) in FIG. 2. The microcontroller (5) uses its memory storage (29) to keep a copy of the inventory. The inventory will be constant, except if an item is removed from the cabinet or if new items get added to the cabinet.

The cabinet itself has an ID number.

If an item is removed from the mini-bar (24) the microcontroller (5) sends the ID code of the missing item along with the cabinet ID number to its radio transmitter (3) and out its antenna (2) in FIG. 2. In some cases this transmitter will be a wireless internet link (WiFi) and in some cases it will be a standard data radio transmitter such as is used in a key fob to open a car door.

Near the wall, and near either the telephone line or the internet connection there will be either a standard wireless internet router or the receiver for the data radio transmissions that are sent from the cabinet (24). See FIG. 1 for the details. This router or data radio will receive the transmission showing the items used and the cabinet or room ID number.

After the data is received it is delivered to the hotel room service billing system via the internet or through the phone line or through another Building-wide Communication Network (BCN)(17).

The data is received by a special mini-bar billing computer or it will be sent directly to the front desk computer for billing.

### Data Processing

A standard computer is used to receive the data. This computer collects the data on the guest usage of the mini-bar items and sends billings along to the hotel front desk computer system. By this method the charges are added to the guest's bill. Alternatively the data could be sent directly to the front desk computer if it was programmed to also compute the mini-bar charges.

### Description—Additional Embodiment

In addition, a door sensor could be added to the mini-bar to detect that the mini-bar door was opened.

### Operation—Additional Embodiment

The door status information would be sent out by the transmitter just as described above, for the RFID tags.

An alternative method of detection would be to put the reader in the door of the mini-bar and program it to have a narrow range of operation such that only if the items are removed from the cabinet do the tags get read. The diagram does not show this method as it is not the preferred method.

### Alternate Communication Methods

The two main methods of communication through the building will be via the internet or the telephone. However, other Building-wide Communication Networks (BCN) can be used including inductive loop systems, a network of wires, radio or any other convenient means of building-wide communication.

If a WiFi link was used right at the mini-bar then an existing wireless internet system in the building would eliminate the need for the wall communication unit in FIG. 1.

### Conclusion, Ramifications and Scope

These are the details of an auto-billing mini-bar system for hotels, hospitals or other buildings. When guests remove items from the cabinet they are automatically billed for these items. The data is transmitted wirelessly to a building wide communication network. This network uses any means of communication that exists or could be built into a building. Examples are telephone, inductive communication, internet methods or other convenient building networking system. Within the room a wireless connection is established between the mini-bar and the link on the wall that sends the information out to either a computer dedicated to mini-bar accounting or directly to the front desk computer. By this combination of RFID tags and communication networks, both wireless and wired, the automatic billing system is created.

There have been many attempts over the last few decades to automate mini-bar charges in hotels. The authors have been engaged in research along these lines for over a decade and have seen the need for an automated in-room mini-bar system that simply charges the room for any items removed from the cabinet automatically. The device presented here appears to be the first solution to this problem.

The above description should not be construed as a limitation on the scope of the invention, but rather as an example of one preferred embodiment. Many other variations are possible. Control of drug cabinets in hospitals and pharmacies would represent a second application. Manual methods of inventory control are currently employed in hospitals. We have based our examples on mini-bar or convenience bar applications but the other applications of the technology would include any cabinet containing items that need to be controlled.

The scope of the invention should not be determined by the embodiments illustrated, but by the appended claims and their legal equivalents.

What is claimed is:

1. A mini-bar comprising:
A storage cabinet,
A plurality of radio frequency identification (RFID) tags, and
A plurality of consumable items,
Wherein the items are sealed in packaging material inside the cabinet, and the items are labeled with the RFID tags.

2. The mini-bar of claim 1, further comprising:
RFID tags,
Wherein said tags form a seal on the packaging material.

3. The mini-bar of claim 1, further comprising:
A transparent glass door, said glass coated with transparent conductive coating,
Wherein the coating will block RFID communication outside the cabinet.

4. The mini-bar of claim 3,
Wherein the blocked RFID communication from one of the labeled items indicates that the item has been removed from the mini-bar or that the packaging has been opened.

5. The mini-bar of claim 1, further comprising:
A communication system for a building,
Wherein said communication system will transmit the information that the labeled item was removed from the inside of the radio shielded storage cabinet, or the labeled item has been opened.

6. The mini-bar of claim 5, wherein said communication system is a wireless or wired internet, an inductive loop communication system or a system of wires and radios to communicate with a central computer system.

7. The mini-bar of claim 6, wherein the central computer system keeps an inventory of all the items which are labeled with RFID tags, which leave and enter the cabinet.

8. A system for monitoring the activity of a mini-bar comprising:
A plurality of radio frequency identification (RFID) tags attached to consumable items, the tags configured to transmit information about the items, and
A monitoring device receptive to the signals from the radio frequency identification tags, the monitoring device configured for receiving information about the consumable items in the mini-bar.

9. The system of claim 8, wherein the RFID tag is configured to signal a change in the position or status of the item to which it is attached.

10. The system of claim 9, wherein the change in the item status comprises an item that has been removed from the mini-bar.

11. The system of claim 9, wherein the change in the item status comprises an item that has been opened.

12. The system of claim 8, wherein the system is in communication with a central computer system.

13. The system of claim 12, wherein the communication system is a wireless or wired internet, an inductive loop communication system or a system of wires and radios.

14. A method for monitoring activity of a mini-bar comprising:
Monitoring signals from items contained inside the mini-bar.

15. The method of claim 14, further comprising:
Processing the signals from the items inside the mini-bar to determine a difference from signals acquired previously.

16. The method of claim 15, wherein the difference comprises a removed item.

17. The method of claim 16, further comprising:
Processing the signals to generate a report of items remaining or items missing from the mini-bar.

18. The method of claim 17, further comprising:
Transmitting the report to a central computer system.
